(19) United States
(12) Patent Application Publication
(10) Pub. No.: US 2009/0196026 A1
(43) Pub. Date: Aug. 6, 2009

(54) PURSE LIGHT

(76) Inventors: Devin R. Finke, Spring, TX (US); Alan E. Lauve, Magnolia, TX (US)

Correspondence Address: MICHAEL A. O'NEIL, P.C., 5949 SHERRY LANE, SUITE 820, DALLAS, TX, 75225, US

(21) Appl. No.: 12/366,188

(22) Filed: Feb. 5, 2009

Related U.S. Application Data
(60) Provisional application No. 61/026,566, filed on Feb. 6, 2008.

(51) Int. Cl. F21V 33/00

(52) U.S. Cl. 362/156

(57) ABSTRACT

A purse light for illuminating the interiors of purses and other containers comprises a pair of highly flexible plastic sheets having a serpentine-shaped light source secured therebetween. The purse light is positioned within a container and extends along the interior sidewalls and bottom wall thereof. When activated the light source illuminates the interior of the container.

### CROSS-REFERENCE TO RELATED APPLICATION

Applicant(s) claim priority based on U.S. Provisional Patent Application No. filed Feb. 6, 2008, the entire content of which is incorporated herein by reference.

### DESCRIPTION OF THE DRAWINGS

FIG. 1 is an exploded perspective view illustrating a purse light comprising the present invention;

FIG. 1A is an enlarged partial sectional view take along the line 1A-1A in FIG. 1;

FIG. 2 is an exploded perspective view illustrating the installation of the purse light of FIG. 1 into a purse;

FIG. 3 is a sectional view showing the purse light of FIG. 1 installed in a purse;

FIG. 4 is a perspective view illustrating the operation of the present invention when installed in a purse;

FIG. 5 is a perspective view of a purse light comprising the present invention installed in a back pack; and

FIG. 6 is a schematic diagram of electronic circuitry that can be utilized in purse lights comprising the present invention.

### DETAILED DESCRIPTION

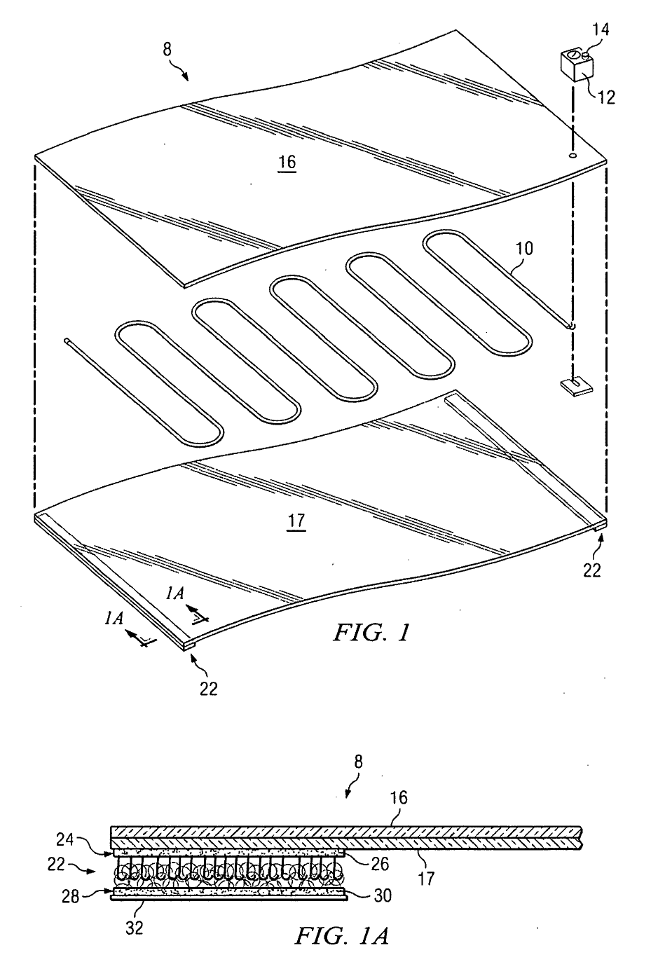

Referring to FIG. 1, a purse light 8 comprises a length of fiber optic material 10 extending in serpentine fashion from a battery pack 12 equipped with an on/off switch 14. The length of fiber optic material 10 is sandwiched between a pair of transparent plastic sheets including upper sheet 16 and lower sheet 17. The serpentine-shaped length of fiber optic material is secured in place by bonds 18 which join the sheets 16 and 17 to one another.

Either the inside surface or the outside surface of the transparent plastic sheet 17 may be coated with a layer of light reflecting material. If used the layer of light reflecting material directs light emanating from the length of fiber optic material 10 through the transparent plastic sheet 16.

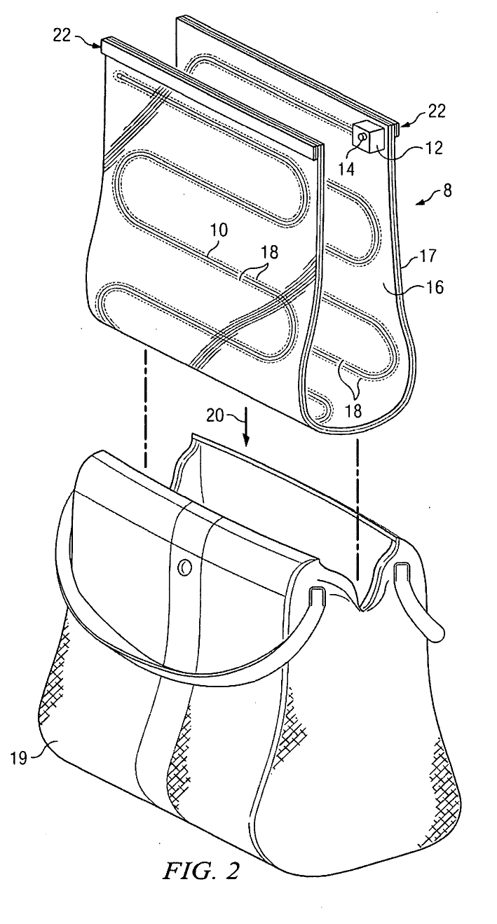

Referring to FIG. 2, the opposed transparent plastic sheets 16 and 17 comprising the purse light 8 are bent into a U-shaped configuration. The entire assembly is then inserted into an empty purse or other container 19 which may be any of the various types typically utilized by men, women and children. Insertion of the purse light 8 comprising the length of fiber optic material 10 and the transparent plastic sheets 16 and 17 into the purse or other container 19 is illustrated by the arrow 20.

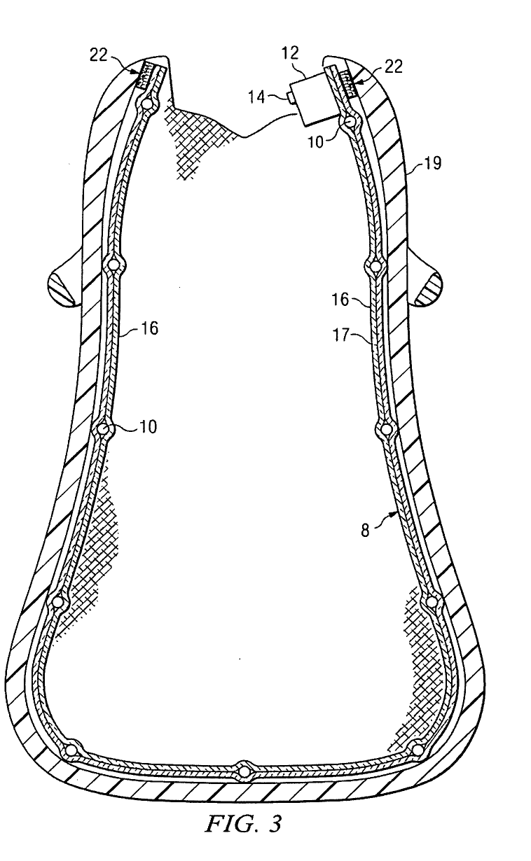

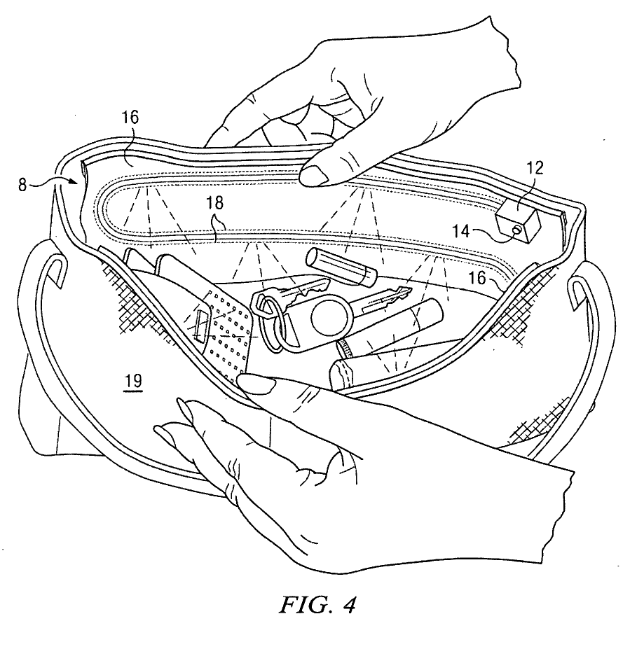

Referring to FIGS. 3 and 4, when the purse light 8 is inserted into the purse or other container 19 the transparent plastic sheets 16 and 17 extend along the interior sides and the bottom thereof. The purse light 8 is retained in the container 19 by conventional fastening devices, for example, hook-and-loop fasteners 22. When the fiber optic device 10 is actuated it illuminates the interior of the purse or other container 19 from the bottom and sides thereof which facilitates and simplifies finding objects which are contained therein.

Referring to FIG. 1A, each hook and loop fastener 22 comprises a first component 24 comprising a backing layer 26 having first components of the hook and loop fastener 22 secured thereto. The side of the backing layer 26 opposite the hook and loop fasteners 22 is provided with an adhesive layer which permanently bonds the hook and loop fastener 22 to the plastic sheet 17 of the purse light 8. The hook and loop fasteners 22 further comprises a second component 28 comprising a backing layer 30 having second components of the hook and loop fasteners 22 secured thereto. The backing layer 30 is provided with an adhesive layer disposed on the opposite side thereof from the components of the hook and loop fasteners 22. The adhesive layer of the second component 28 is initially covered by a protective layer 32. When the purse light 8 is installed in a container the protective layer 32 is removed thereby facilitating an adhesive bond between the layer 30 and the inside surface of the container in which the purse light 8 is installed.

The use of the hook and loop fasteners 22 facilitates transfer of the purse light 8 from a first container in which it is initially installed to second and subsequent containers as circumstances dictate. For example, purse light 8 might be initially installed in an everyday purse or other container. As the seasons change the purse light 8 can be removed from the initial container and installed in a second or subsequent container depending upon the preferences of the person utilizing the purse light 8. Use of the hook and loop fasteners 22 also facilitates the transfer of the purse light 8 on a temporary basis such as installing the purse light 8 in a very formal purse or other container for evening wear, installing the purse light 8 in a beach bag or other highly informal container for vacation usage, etc.

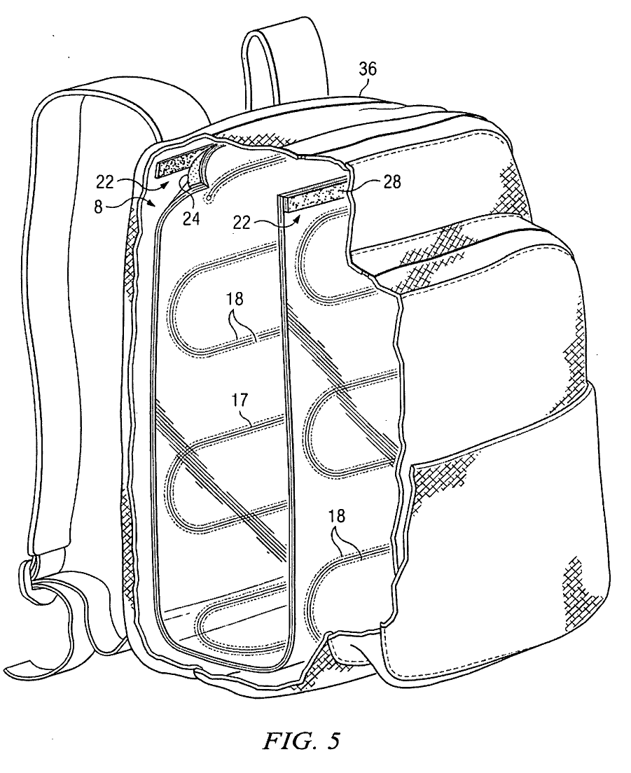

FIG. 5 illustrates the purse light 8 installed in a back pack 36. Those skilled in the art will readily appreciate the fact that the purse light 8 can be configured in a wide variety of sizes and is therefore readily adapted to usage in containers that are relatively small, intermediate in size, or relatively large. The size and configuration of the purse light 8 can be adapted to the size and shape of any particular container.

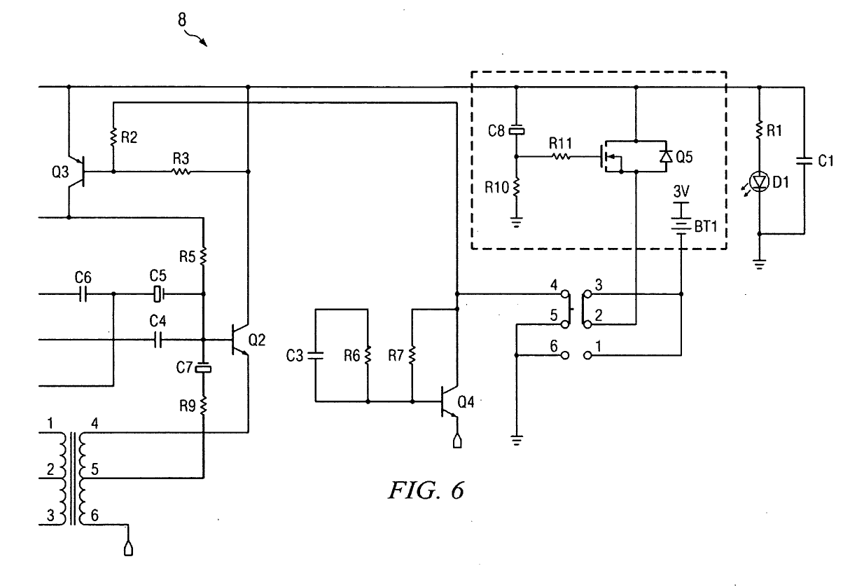

FIG. 6 is a schematic illustration of an electronic circuit that may be utilized in the operation of the purse light 8. The circuit shown in FIG. 6 is illustrative only, it being understood that various types and kinds of electronic circuits can be utilized in the practice of the invention.

As will be appreciated by those skilled in the art, the purse light of the present invention is installed in an empty purse or other container. Thereafter items to be carried are deposited therein. The purse light thereafter directs light upwardly and inwardly through the items in the container thereby facilitating identification and retrieval of the selected items therefrom.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An apparatus for illuminating the interior of a container having opposed interior side surfaces and a bottom surface comprising:
a pair of highly flexible plastic sheets having substantially identical length and width dimensions and substantially identical edges;
at least one of the plastic sheets being highly transparent;
means for securing the plastic sheets in an overlying relationship with the edges of the sheets being substantially aligned;
a serpentine-shaped light source;
means for securing the serpentine-shaped light source between the plastic sheets and for preventing movement of the serpentine-shaped light source relative to the plastic sheets;
a power source and control box mounted on the plastic sheets for controlling the operation of the serpentine-shaped light source; and
means for securing the plastic sheets within the container with the transparent plastic sheet exposed to the interior of the container and with the other plastic sheet engaging the interior side walls and the interior bottom wall of the container;
whereby the interior of the container is illuminated upon activation of the serpentine-shaped light source.
